(19) United States
(12) Patent Application Publication
(10) Pub. No.: US 2017/0241815 A1
(43) Pub. Date: Aug. 24, 2017

(54) INDICATING DEVICE WITH LIGHT-DIRECTING CONFIGURATION

(71) Applicants: DENSO International America, Inc., Southfield, MI (US); DENSO CORPORATION, Kariya-city (JP)

(72) Inventor: Jagadeesh KRISHNAMURTHY, Troy, MI (US)

(73) Assignees: DENSO International America, Inc., Southfield, MI (US); DENSO CORPORATION, Kariya-city (JP)

(21) Appl. No.: 15/051,931

(22) Filed: Feb. 24, 2016

(51) Int. Cl. G01D 13/28; G01D 13/02

(52) U.S. Cl. CPC G01D 13/28; G01D 13/02

(57) ABSTRACT

A pointer is rotational relative to a dial plate. The pointer includes a pointer shaft, which is non-opaque. A driver unit includes a drive shaft coaxial with the pointer shaft. A light source is configured to emit light. The pointer shaft has a pointer end having a pointer reflective surface. The pointer reflective surface is configured to receive light, which is incident radially inward, and to reflect the light to direct the light along an axial direction of the pointer shaft to pass through the pointer shaft.

### TECHNICAL FIELD

The present disclosure relates to an indicating device.

### BACKGROUND

Conventionally, an indicating device such as a dial gauge includes a pointer rotational to indicate information such as a speed or an engine revolution of a vehicle. An indicating device may have an illuminative configuration including a light source and a light pickup. The light pickup receives light emitted from the light source and directs the light for illumination.

### SUMMARY

According to an aspect of the preset disclosure, a pointer may be rotational relative to the dial plate. The pointer may include a pointer shaft, which is non-opaque. A driver unit may include a drive shaft coaxial with the pointer shaft. A light source may emit light. The pointer shaft may have a pointer end having a pointer reflective surface. The pointer reflective surface may receive light, which is incident radially inward, and may reflect the light to direct the light along an axial direction of the pointer shaft to pass through the pointer shaft.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing an indicating device of a first embodiment;

FIG. 2 is a perspective view showing components of the indicating device;

FIG. 3 is a perspective sectional view showing a part of the indicating device;

FIG. 4 is an explanatory view showing components of the indicating device;

FIG. 5 is an explanatory view showing optical paths in the components;

FIG. 6 is a sectional view showing an indicating device of a second embodiment;

FIG. 7 is an explanatory view showing optical paths of the second embodiment; and

FIG. 8 is an explanatory view showing components and optical paths of a variation of the second embodiment.

### DETAILED DESCRIPTION

### First Embodiment

As follows, an indicating device 1 will be described with reference to drawings. In drawing(s), “VERTICAL” may correspond to a vertical direction. “AXIAL” may correspond to an axial direction. “RADIAL” may correspond to a radial direction. “CIRCUMFERENTIAL” may correspond to a circumferential direction.

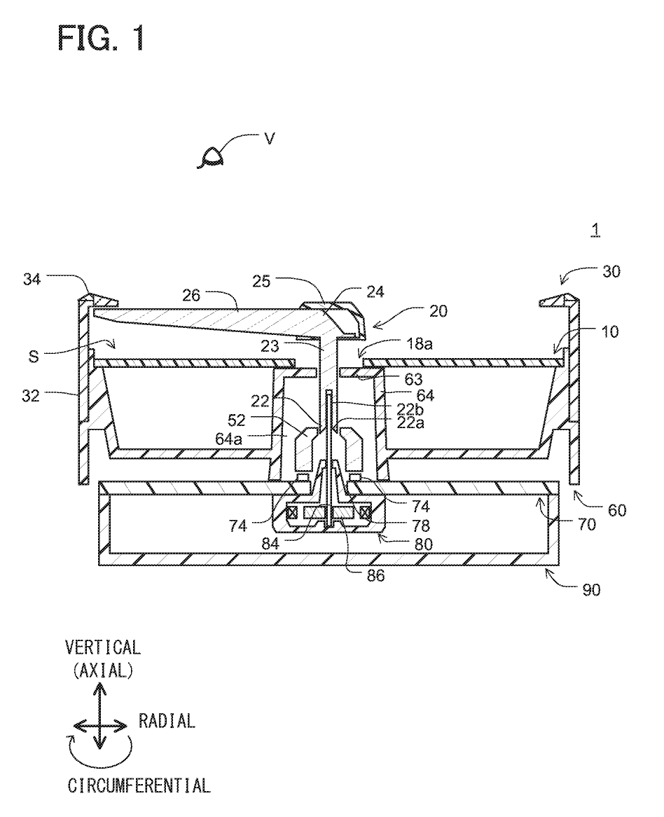

In FIG. 1, the indicating device 1 is, for example, an engine revolution meter for an automobile. The indicating device 1 includes a pointer 20, a light pickup 52, a dial plate 10, a dial cover 30, a main housing 60, a printed circuit board (PCB) 70, a driver unit 80, and a rear housing 90.

The dial plate 10 has a display surface facing a viewer V such as an occupant of an automobile. The dial plate 10 is in a circular shape when viewed from the viewer V. The dial plate 10 has indication marks such as a dial gauge and symbols S to form a gauge meter. The symbols S may be numbers to denote engine revolution. The dial plate 10 may be formed of resin such as polycarbonate. The dial plate 10 has a center hole 18a at its center.

The dial cover 30 is a tubular member placed above the dial plate 10. The pointer 20 is inserted in the center hole 18a of the dial plate 10. The pointer 20 is located adjacent to the display surface of the dial plate 10. The pointer 20 includes a pointer shaft 23, a body 24, a needle 26, and a cover 25.

In the example, the pointer shaft 23, the body 24, and the needle 26 are formed of a non-opaque light-conductive material such as a translucent resin (e.g., polycarbonate resin or PMMA resin). The needle 26 is substantially at a right angle relative to the pointer shaft 23. The body 24 and the needle 26 are located above the center hole 18a of the dial plate 10. The pointer shaft 23 extends through the center hole 18a. The cover 25 is formed of an opaque material such as ABS resin. The cover 25 is coupled with the body 24 to enclose the body 24.

The PCB 70 is located between the main housing 60 and the rear housing 90. The PCB 70 has a center hole 78 at its center. The PCB 70 is equipped with electronic wirings and electronic devices such as a microprocessor. The PCB 70 is further equipped with light emitting diodes (LED, light source) 74 around the center hole 78.

The driver unit 80 is equipped to the PCB 70. For example, the driver unit 80 may be soldered to the PCB 70. The driver unit 80 may be an electric motor such as a stepper motor. The driver unit 80 includes a drive shaft 84 and a motor portion 86. The drive shaft 84 is coupled with a rotor of the motor portion 86. The motor portion 86 includes a stator configured to receive electricity from a controller (not shown) via the wiring of the PCB 70 to generate a magnetic field and to drive the drive shaft 84 via the rotor. The driver unit 80 may be equipped with reduction gears combined with the motor portion 86. The drive shaft 84 is coupled with the pointer shaft 23 of the pointer 20 to manipulate the pointer 20 at an appropriate position to point the tick marks and the symbols S on the dial plate 10.

The main housing 60 includes a housing center 64 defining a tubular hollow 64a. The housing center 64 has a brim 63 extending radially inward toward the pointer shaft 23. The light pickup 52 and a part of the pointer shaft 23 are located in the tubular hollow 64a. The rear housing 90 is equipped to the PCB 70 to accommodate the driver unit 80.

The pointer shaft 23 has a pointer end 22 in the axial direction of the pointer shaft 23. The pointer end 22 is located on the side of the driver unit 80. The pointer end 22 has a drive shaft hole 22b into which the drive shaft 84 is inserted.

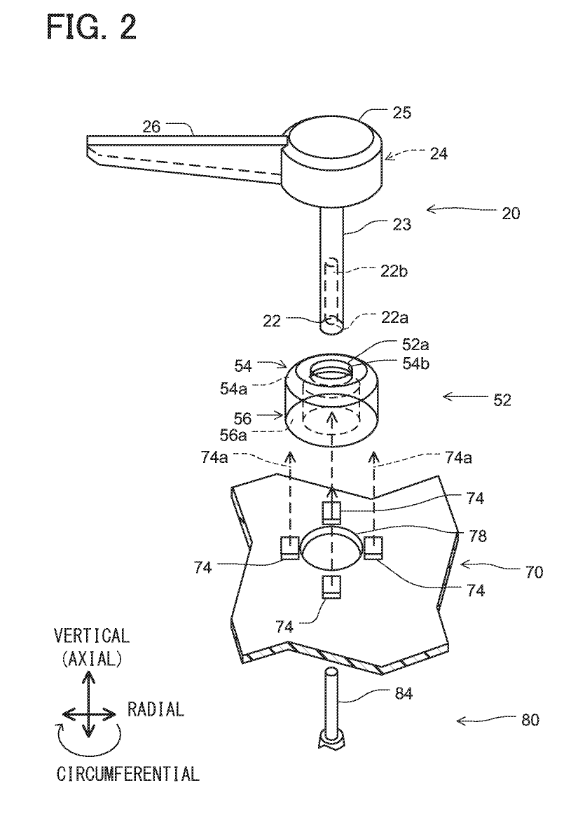

In FIG. 2, the pointer 20 is coupled with the drive shaft 84 of the driver unit 80 through a center hole 52a of the light pickup 52 and the center hole 78 of the PCB 70. The drive shaft 84 of the driver unit 80 is inserted into the drive shaft hole 22b of the pointer shaft 23, such that the drive shaft 84 is located to be coaxial with the pointer shaft 23. After the connection, the drive shaft 84 of the driver unit 80 extends through the light pickup 52 and the PCB 70. The pointer shaft 23 and the drive shaft 84 are rotational relative to the light pickup 52 and PCB 70.

The LEDs 74 include multiple light source elements 74 located on the radially outside of the drive shaft 84 to surround the drive shaft 84. The LEDs 74 are positioned on the PCB 70, such that the pickup receiving surface 56a of the light pickup 52 is opposed to optical axes 74a of the LEDs 74.

The light pickup 52 is formed of a non-opaque light-conductive material such as a translucent resin (e.g., polycarbonate resin or PMMA resin). The light pickup 52 may be formed by injection molding a resin material to be in a cylindrical form. The light pickup 52 may be formed by machining a bulk resin material. The light pickup 52 may have a support structure (not shown) such as a stay fitted to a hole formed in the PCB 70.

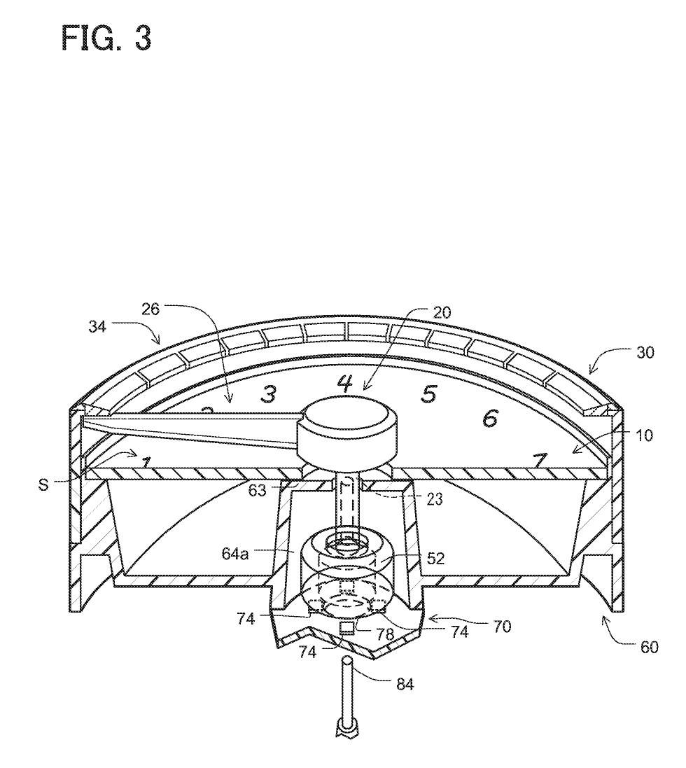

FIG. 3 shows a part of the indicating device 1. The indicating device 1 may be assembled through the following steps. First, the driver unit 80 is soldered on the PCB 70. The light pickup 52 is attached to the PCB 70. The main housing 60 is mounted onto the PCB 70, such that the light pickup 52 is accommodated in the tubular hollow 64a. The dial gauge 10 is mounted onto the main housing 60. The pointer 20 is mounted to the light pickup 52. Finally, the dial cover 30 is mounted onto the dial gauge 10 and the main housing 60. If dimension permits, the dial cover 30 may be mounted onto the dial gauge 10 and the main housing 60, and subsequently, the pointer 20 may be mounted to the light pickup 52.

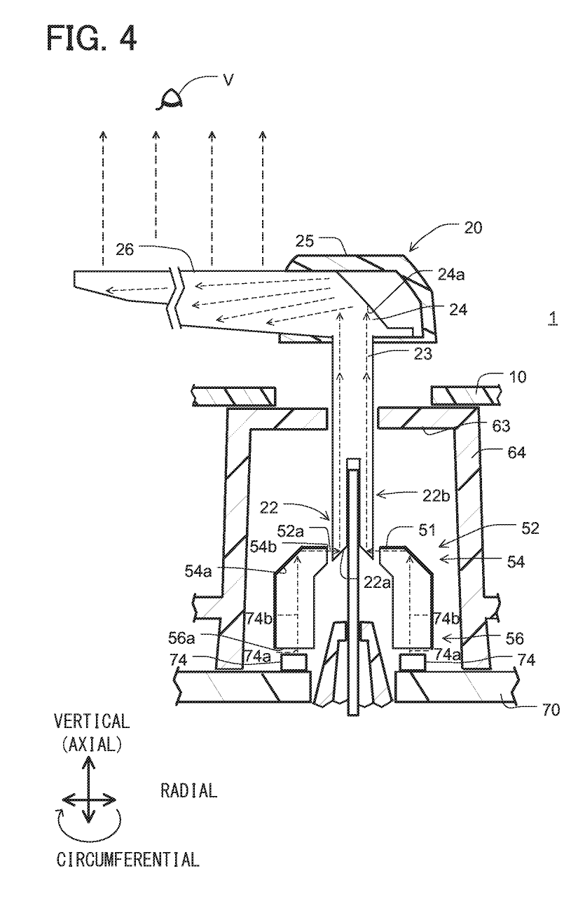

As shown in FIG. 4, the pointer end 22 has a pointer reflective surface 22a. The pointer reflective surface 22a is located on a radially outside of the drive shaft hole 22b to surround the drive shaft hole 22b in the circumferential direction. The pointer reflective surface 22a is in a dented conical shape and is angled relative to the axial direction. In the present example, the pointer reflective surface 22a is angled at 45 degrees relative to the axial direction.

The light pickup 52 has a receiving end 56 and an emitting end 54 on both sides in the axial direction. The receiving end 56 has a pickup receiving surface 56a opposed to the LEDs 74 in the axial direction. The emitting end 54 has a pickup emitting surface 54b opposed to the pointer reflective surface 22a inward in the radial direction. In this way, the light pickup 52 being non-opaque object is opposed to the LEDs 74 and opposed to the pickup reflective surface 54a.

The emitting end 54 has a chamfered angled periphery forming a pickup reflective surface 54a on its radially outside. The pickup reflective surface 54a is in an annular shape and is angled relative to the axial direction. In the present example, the pickup reflective surface 54a is angled at 45 degrees relative to the axial direction. The emitting end 54 has a brim 51 on its radially inside. The brim 51 is extended inward in the radial direction toward the pointer reflective surface 22a. The brim 51 has the center hole 52a into which the pointer end 22 is inserted in the axial direction.

The relative position between the brim 51 and the pointer shaft 23 is adjusted such that a tip end of the pointer end 22 is positioned in the center hole 52a of the brim 51. More specifically, the pointer reflective surface 22a is positioned in the center hole 52a of the brim 51, such that the pointer reflective surface 22a is opposed to the pickup reflective surface 54a in the radial direction through the pickup emitting surface 54b and the brim 51. That is, the pointer reflective surface 22a and the pickup reflective surface 54a form a coupled mirror structure.

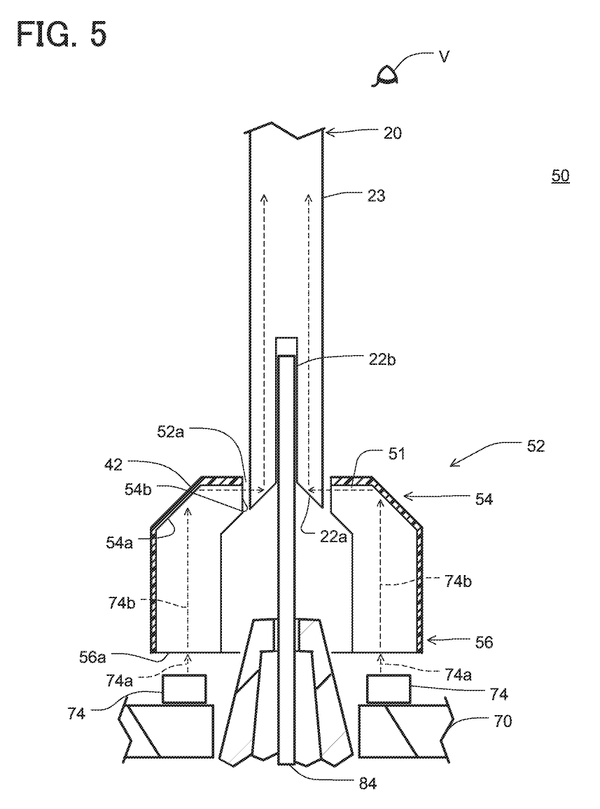

Subsequently, one example of a trajectory of light will be described. As shown in FIG. 5, when each of the LEDs 74 is energized, the LED 74 emits light along an optical axis 74a. The light advances toward the pickup receiving surface 56a in the axial direction. The light pickup 52 conducts the light along an optical path 74b to advance along the axial direction toward the pickup reflective surface 54a. The pickup reflective surface 54a receives the light, which is incident along the axial direction, and reflects the light perpendicularly in the radial direction. In this way, the light pickup 52 changes the direction of the light, which is incident along the axial direction, into the radial direction. Thus, the light pickup 52 directs the light radially inward toward the pointer reflective surface 22a through the brim 51, the pickup emitting surface 54b, and the center hole 52a.

The pointer end 22 conducts the light inward in the radial direction to advance toward the pointer reflective surface 22a. The pointer reflective surface 22a receives the light and reflects the light perpendicularly in the axial direction of the pointer shaft 23. In this way, the pointer end 22 further changes the direction of the light, which is incident inward in the radial direction, into the axial direction. Thus, the pointer end 22 directs the light in the axial direction to pass through the pointer shaft 23. In this way, the light pickup 52 and the pointer shaft 23 form the optical path 74b in a zigzag form including two reflections.

In FIG. 4, the pointer shaft 23 further conducts the light from the pointer reflective surface 22a toward an angled surface 24a of the body 24. The angled surface 24a receives the light and reflects the light perpendicularly to the incident direction. In this way, the body 24 further changes the direction of the light at the angled surface 24a toward the needle 26. The needle 26 further reflects the light toward the viewer V. In this way, the light illuminates the needle 26, and the illuminated needle 26 is rendered viewable for the viewer V.

In FIG. 5, in this example, the light pickup 52 is equipped with a shield 42. The shield 42 is opaque and located to cover the exterior of the light pickup 52. The shield 42 may be formed by plating metallic material on the light pickup 52. Alternatively or in addition, the shield 42 may be molded of opaque resin or reflective metallic material and may be affixed to the light pickup 52. That is, the light pickup 52 and the shield 42 form a layered and laminated structure. Light emitted from the LEDs 74 enters through the pickup receiving surface 56a into the light pickup 52. The light passing through the light pickup 52 may further pass through the pickup reflective surface 54a linearly. In the present example, the light passing through the pickup reflective surface 54a is blocked by the shield 42. Thus, the light hardly leaks from the light pickup 52.

### Second Embodiment

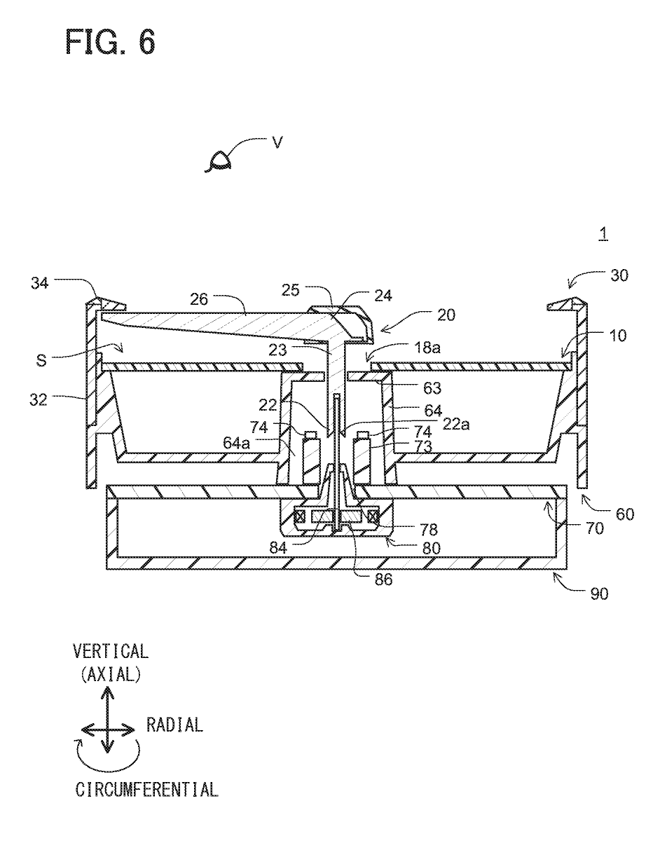

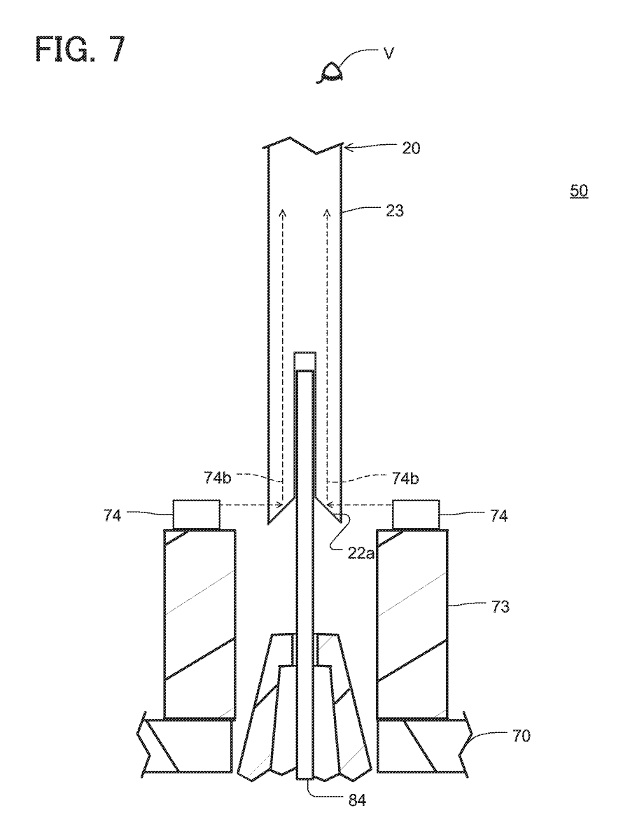

As shown in FIGS. 6 and 7, the light pickup 52 in the first embodiment may be omitted. In this example, a spacer 73 is inserted between the LEDs 74 and the PCB 70 to elevate the LEDs 74 in the axial direction to the level same as the pointer reflective surface 22a of the pointer end 22. The spacer 73 may be a tubular member formed of, for example, a resin material. Thus, the LEDs 74 are opposed to the pointer reflective surface 22a inward in the radial direction. In the present embodiment, the LEDs 74 are configured to emit light radially inward toward the pointer reflective surface 22a.

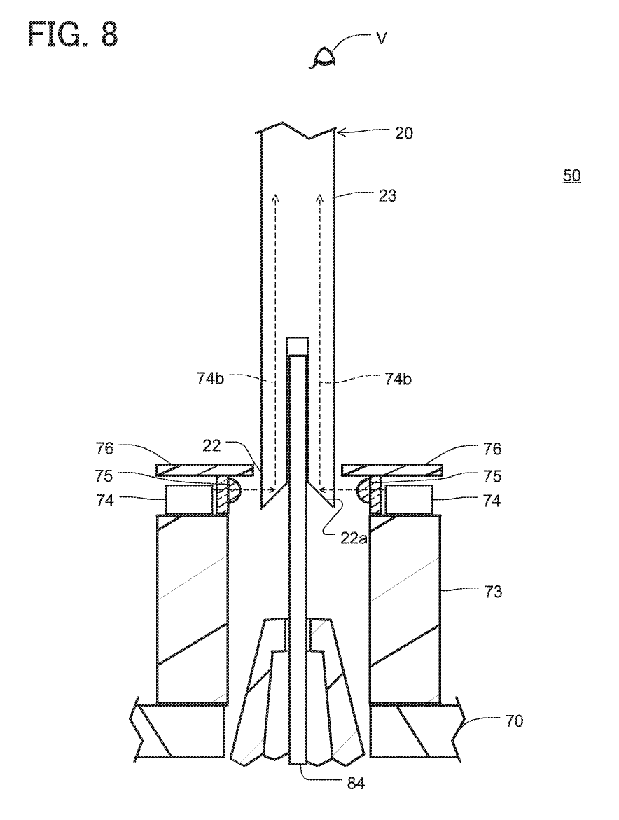

As shown in FIG. 8, lens 75 may be provided between the LEDs 74 and the pointer reflective surface 22a. The lens 75 may be equipped in front of the LED74. The lens 75 may be formed of non-opaque material, such as translucent resin. The lens 75 may be a convex lens projected radially inward toward the pointer reflective surface 22a to converge the light from the LEDs 74 toward the pointer reflective surface 22a. The lens 75 may restrict light from scattering around the pointer end 22.

A shield 76 in a plate shape may be equipped above the LEDs 74 and the lens 75. The shield 76 may be a disc-shaped member formed of, for example opaque material such as ABS resin. The shield 76 extends radially inward beyond the lens 75. The shield 76 has an inner periphery forming a roof located close to the pointer end 22. The shield 76 extends radially outward beyond the LEDs 74 to cover the upper side of the LEDs 74 entirely. In the present configuration, the shield 76 is located between the LEDs 74 and the dial plate 10 (FIG. 6) to restrict light from leaking toward the dial plate 10.

### Other Embodiments

The indicating device 1 may be used in various control panels or instrument panels, such as a speedo meter, a fuel meter, or a mileage meter, other than the engine revolution meter.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An indicating device comprising:
a dial plate;
a pointer rotational relative to the dial plate, the pointer including a pointer shaft, which is non-opaque;
a driver unit including a drive shaft coaxial with the pointer shaft; and
a light source configured to emit light, wherein
the pointer shaft has a pointer end having a pointer reflective surface, and
the pointer reflective surface is configured to receive light, which is incident radially inward, and to reflect the light to direct the light along an axial direction of the pointer shaft to pass through the pointer shaft.

2. The indicating device according to claim 1, wherein
the light source includes a plurality of light source elements located on a radially outside of the drive shaft to surround the drive shaft.

3. The indicating device according to claim 2, wherein
the pointer end has a drive shaft hole into which the drive shaft is inserted.

4. The indicating device according to claim 3, wherein
the pointer reflective surface is located on a radially outside of the drive shaft hole to surround the drive shaft hole.

5. The indicating device according to claim 4, wherein
the pointer reflective surface is in a conical shape, and
the pointer reflective surface is dented into the pointer end and angled relative to the axial direction.

6. The indicating device according to claim 1, further comprising:
a light pickup being non-opaque, wherein
the light pickup is opposed to the light source and opposed to the pickup reflective surface, and
the light pickup is configured to conduct light emitted from the light source and to reflect the light to direct the light toward the pointer reflective surface.

7. The indicating device according to claim 6, wherein
the light pickup has a pickup reflective surface angled relative to the axial direction, and
the pickup reflective surface is configured to receive light emitted from the light source and to reflect the light toward the pointer reflective surface.

8. The indicating device according to claim 7, wherein
the light pickup has a pickup receiving surface and a pickup emitting surface,
the light pickup is configured to receive light emitted along the axial direction though the pickup receiving surface, and
the light pickup is configured to reflect the light on the pickup reflective surface to direct the light toward the pointer reflective surface through the pickup emitting surface.

9. The indicating device according to claim 8, wherein
the light pickup is in a cylindrical shape having a receiving end and an emitting end,
the receiving end has the pickup receiving surface opposed to the light source in the axial direction, and
the emitting end has the pickup emitting surface opposed to the pointer reflective surface radially inward.

10. The indicating device according to claim 9, wherein
the emitting end has a chamfered angled periphery in an annular shape, and
the chamfered angled periphery forms the pickup reflective surface.

11. The indicating device according to claim 10, wherein
the emitting end has a brim extended radially inward toward the pointer reflective surface.

12. The indicating device according to claim 6, wherein
the light pickup has a center hole in which the pickup reflective surface is located.

13. The indicating device according to claim 1, further comprising:
a shield being opaque and located to cover an exterior of the light pickup.

14. The indicating device according to claim 5, wherein
the pointer reflective surface is angled at 45 degrees relative to the axial direction.

15. The indicating device according to claim 10, wherein
the pickup reflective surface is angled at 45 degrees.

16. The indicating device according to claim 2, wherein
the plurality of light source elements is opposed to the pointer reflective surface radially inward to emit light toward the pointer reflective surface.

17. The indicating device according to claim 16, further comprising:
a lens located between each of the light source elements and the pointer reflective surface.

18. The indicating device according to claim 16, further comprising:
a shield being in a plate shape, wherein
the shield is located between the light source elements and the dial plate.
